(19) United States
(12) Patent Application Publication
(10) Pub. No.: US 2012/0200381 A1
(43) Pub. Date: Aug. 9, 2012

(54) Molded Coil and Manufacturing Method Thereof

(75) Inventors: Motoaki KIMURA, Kyoto-fu (JP); Takashi Fujimura, Kyoto-fu (JP)

(73) Assignee: Suncall Corporation, Kyoto-shi (JP)

(21) Appl. No.: 13/349,093

(22) Filed: Jan. 12, 2012

(30) Foreign Application Priority Data
Feb. 7, 2011 (JP) 2011-023877

(51) Int. Cl. H01F 27/28; B05D 5/12; H01F 27/02

(52) U.S. Cl. 336/96; 427/116

(57) ABSTRACT

A molded coil according to the present invention includes a coil body that is formed by an elongated insulation-coated conductor. The coil body has a spiral portion winded around in a spiral manner, a first end portion forming a beginning end of the spiral portion, and a second end portion forming a terminating end of the spiral portion. The molded coil also includes an insulative locking member that keeps a shape of the spiral portion so as to prevent the spiral portion from expanding in a vertical direction, and an insulative resin body that covers the spiral portion with the locking member being attached thereto.

### BACKGROUND OF THE INVENTION

1. Field of the Invention

The present invention relates to a molded coil including a coil body formed so as to have a spiral portion, a first end portion and a second end portion, wherein at least the spiral portion is sealed by resin, and relates to a manufacturing method of the molded coil.

2. Related Art

A molded coil configured so that at least a spiral portion of a coil body formed by an insulation-coated conductor is sealed by a resin has been widely utilized for insulation performance, compactness, handleability or the like.

The molded coil includes the coil body that is formed by the elongated insulation-coated conductor and has a spiral portion winded around in a spiral manner, a first end portion forming a beginning end of the spiral portion and a second end portion forming a terminating end of the spiral portion. The thus configured molded coil is manufactured by covering or sealing at least the spiral portion with resin.

It has been proposed to use a die and a spacer so that the resin covering the spiral portion has a constant thickness (see, for example, Japanese unexamined patent publication No. 2010-021506, which is hereinafter referred to as prior art document 1).

More specifically, the die disclosed in the prior art document 1 includes a hollow first die that has a peripheral wall surrounding the spiral portion, a bottom wall and an upper opening; a solid second die that is inserted into a hollow portion of the spiral portion; and a third die that closes the upper opening of the first die.

A resin is injected into the die in a state where the coil body has been installed within the first die so that the spiral portion to be sealed surrounds the second die, and respective spacers have been interposed between an inner side surface of the first die and an outer side surface of the spiral portion and between an inner side surface of the spiral portion and an outer side surface of the second die.

The manufacturing method disclosed by the prior art document 1 is useful in that the thickness of the resin, which surrounds the spiral portion, can be controlled by the spacer, but necessitates the die in which the spiral portion is installed. Accordingly, it is not possible to seal the spiral portion with the resin by dipping or spraying, resulting in a problem that manufacturing time and cost would be increased.

### SUMMARY OF THE INVENTION

The present invention has been made in view of the above conventional art, and it is an object thereof to provide a molded coil including a coil body that is formed by an insulation-coated conductor and has a spiral portion sealed with a resin, the molded coil allowing the spiral portion to be easily and efficiently sealed with the resin without using a die, and a manufacturing method of the molded coil.

In order to achieve the object, the invention provides a molded coil including a coil body, an insulative locking member and an insulative resin body. The coil body is formed by an elongated insulation-coated conductor and has a spiral portion winded around in a spiral manner, a first end portion forming a beginning end of the spiral portion and a second end portion forming a terminating end of the spiral portion. The insulative locking member keeps a shape or posture of the spiral portion so as to prevent the spiral portion from expanding in a vertical direction. The insulative resin body covers the spiral portion with the locking member being attached thereto.

The molded coil according to the present invention makes it possible to easily and rapidly seal the spiral portion with the resin without using a die, thereby realizing cost reduction thanks to simplification of a manufacturing device and improvement of manufacturing efficiency.

In a case where a spiral forming region of the insulation-coated conductor that forms the spiral portion includes an inner side surface facing inward in a radial direction, an outer side surface facing outward in the radial direction, an upper end surface connecting upper ends of the inner and outer side surfaces, and an lower end surface connecting lower ends of the inner and outer side surfaces, and has a tapered cross section in which a thickness becomes thin as it goes from the inner side surface toward the outer side surface, the locking member preferably keeps the spiral portion in a compressed state in a vertical direction in which the upper end surface of the spiral forming region of one turn in the spiral portion is brought into contact with the lower end surface of the spiral forming region of a next turn that is upwardly adjacent to the one turn so that the spiral portion becomes lower in the vertical direction as it goes from the inner side toward the outer side in the radial direction.

The locking member is preferably embodied by an insulative tape wrapped around the inner side surface, the upper end surface, the outer side surface and the lower end surface of the spiral portion.

The present invention also provides a manufacturing method of a molded coil including a coiling step, a coating step, a locking step and a sealing step. The coiling step forms from an elongated conductive wire a coil body including a spiral portion winded around in a spiral manner, a first end portion forming a beginning end of the spiral portion and a second end portion forming a terminating end of the spiral portion. The coating step coats at least a portion of the conductive wire that forms the spiral portion with an insulative coat. The locking step keeps a shape of the spiral portion by an insulative locking member so as to prevent the spiral portion from expanding in a vertical direction. The sealing step seals at least the spiral portion with an insulative resin, the spiral portion having the locking member mounted thereto.

The manufacturing method according to the present invention makes it possible that the sealing step for sealing the spiral portion with resin is easily and rapidly performed without using a die, thereby realizing cost reduction thanks to simplification of a manufacturing device and improvement of manufacturing efficiency.

In one embodiment, the elongated conductive wire has a quadrangular cross section defined by a pair of first and second long edges and a pair of first and second short edges. In the coiling step, the coil body is formed by bending the conductive wire using the first short edge as a bending fulcrum and laminating the conductive wire so as to have a plurality of turns. The spiral forming region of the conductive wire that forms the spiral portion has a tapered cross section in which a thickness becomes thin as it goes from an inner side surface facing inward in a radial direction toward an outer side surface facing outward in the radial direction. In the one embodiment, the locking member preferably keeps the spiral portion in a compressed state in the vertical direction in which an upper end surface of the spiral forming region of one turn in the spiral portion is brought into contact with a lower end surface of the spiral forming region of a next turn that is upwardly adjacent to the one turn so that the spiral portion has a height that becomes lower as it goes from the inner side toward the outer side in the radial direction.

For example, the sealing in the sealing step is achieved by dipping at least the spiral portion into an insulative resin solution or spraying at least the spiral portion with an insulative resin in a state where the coil body is suspended.

### BRIEF DESCRIPTION OF THE DRAWINGS

FIGS. 1A and 1B are a top view and a front view of a molded coil according to one embodiment of the present invention, respectively.

FIG. 2 is a process flow diagram of one example of a manufacturing method of the molded coil.

FIG. 3 is a vertical cross sectional view of a spiral portion of the molded coil after a coiling step.

FIG. 4 is a vertical cross sectional view of the spiral portion after a locking step.

FIG. 5 is schematic view of a compressing device that can be used in the locking step.

### DETAILED DESCRIPTION OF THE PREFERRED EMBODIMENTS

Hereinafter, a preferred embodiment of a molded coil according to the present invention will be described, with reference to the attached drawings.

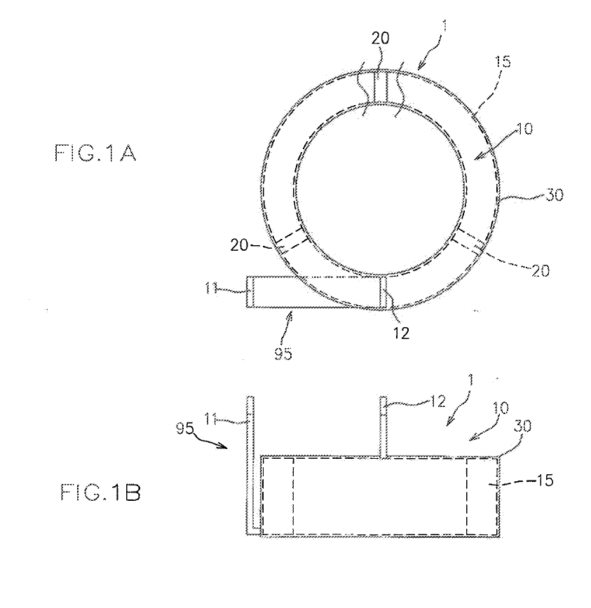

FIGS. 1A and 1B are a top view and a front view of a molded coil 1 according to the present embodiment, respectively.

As shown in FIGS. 1A and 1B, the molded coil 1 includes a coil body 10 that is formed by an elongated insulation-coated conductor 95 and has a spiral portion 15 winded around in a spiral manner, a first end portion 11 forming a beginning end of the spiral portion 15 and a second end portion 12 forming a terminating end of the spiral portion 15, an insulative locking member 20 that keeps a shape of posture of the spiral portion 15 so as to prevent the spiral portion 15 from expanding in a vertical direction, and an insulative resin body 30 that covers or seals the spiral portion 15 with the locking member 20 being attached thereto.

In the molded coil 1, a secondary insulation of the spiral portion 15 by the resin body 30 are realized in a state where the shape or posture of the spiral portion 15 has been kept by the locking member 20, thereby enhancing workability in sealing the spiral portion 15 with the resin body 30.

More specifically, the spiral portion 15 of the coil body 10 is easily expanded and contracted (compressed) in the vertical direction. Accordingly, in the prior art, the spiral portion 15 of the coil body 10 is installed within a die so as to have a fixed posture, and then the resin is injected into the die so that the spiral portion 15 is sealed with the resin.

The prior art configuration necessitates the die, and at the same time takes a long time to install the spiral portion 15 within the die and inject the resin into the die with the spiral portion 15 being installed therein, resulting in a problem that a manufacturing cost would be increased.

On the contrary, the molded coil 1 according to the present embodiment is provided with the locking member 20 that prevents the spiral portion 15 from expanding in the vertical direction, and is configured so that the resin 20 seals the spiral portion 15 with the locking member 20 being attached thereto.

The configuration makes it possible to seal the spiral portion 15 with the resin body 30 while effectively preventing the shape of the spiral portion 15 from being changed, without using the die that has been needed in the prior art. According to the configuration, the sealing of the spiral portion 15 by the resin body 30 can be achieved by dipping the same into resin solution or spraying the same with resin, whereby manufacturing cost would be reduced thanks to improvement of the manufacturing efficiency.

Now, one example of a manufacturing method of the molded coil 1 is explained.

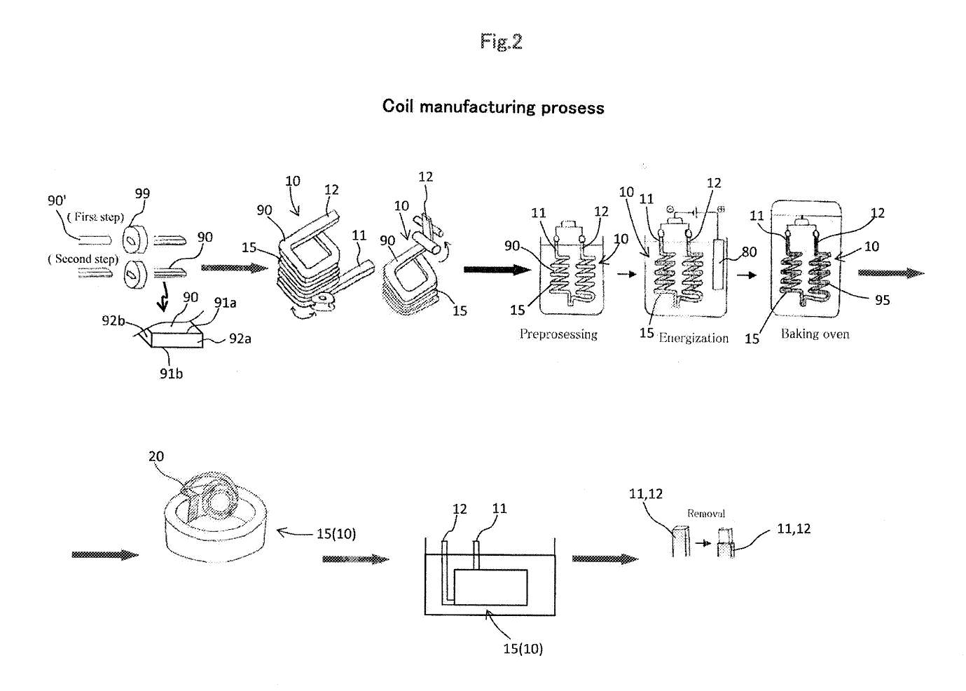

FIG. 2 is a process flow diagram of the one example of the manufacturing method of the molded coil 1.

As shown in FIG. 2, a conductive wire 90 of the insulation-coated conductor 65 has a quadrangular cross section defined by a pair of first and second long edges 91a, 91b and a pair of first and second short edges 92a, 92b.

The conductive wire 90 can be formed by various methods.

In the one example shown in FIG. 2, the conductive wire 90 is formed by inserting a conductive round wire 90′ into a shaping hole of a die 99.

The conductive wire 90 is bent using the first short edge 92a as a bending fulcrum and laminated to have a plurality of turns, so as to form the coil body 10 that includes the spiral portion 15 winded around in a spiral manner, the first end portion 11 forming the beginning end of the spiral portion 15 and the second end portion 12 forming the terminating end of the spiral portion 15.

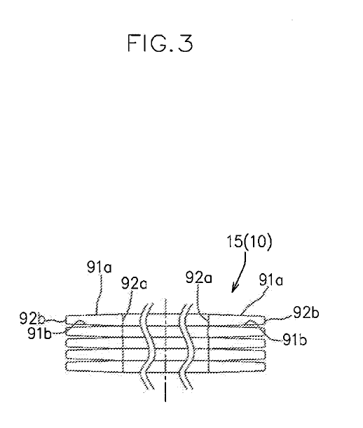

FIG. 3 is a vertical cross sectional view of the spiral portion 15 after the coiling step.

As explained earlier, in the manufacturing method according to the one example, the conductive wire 90 is coiled using the first short edge 92a as the bending fulcrum so that the coil body 10 has an edgewise configuration.

In such a case where the coil body 10 has an edgewise configuration, a spiral forming region of the conductive wire 90 that forms the spiral portion 15 has a tapered cross section in which the thickness becomes thinner from an inner side (the first short edge 92a) facing inward in a radial direction to an outer side (the second short edge 92b) facing outward in the radial direction, as shown in FIG. 3.

The coil body is then coated with an insulative coat.

In the coating step, at least a portion of the conductive wire 90 that forms the spiral portion 15 is coated with the insulative coat.

In the manufacturing method according to the one example, all the regions of the coil body 10 other than an outermost end of the first end portion 11 and an outermost end of the second end portion 12 are coated.

In the one example, the insulative coat is deposited on a surface of the coil body 10 by electrodeposition.

More specifically, as shown in FIG. 2, the coating step includes a preprocessing step in which the surface of the coil body 10 is washed; an electrodepositing step in which the coil body 10 and an electrode member 80 are positioned facing each other within an electrolysis solution with coating particles; and a power voltage is applied to the coil body 10 and the electrode member 80 so that the coil body 10 has a cathode potential and the electrode member 80 has an anode potential; and a baking step in which the insulative coat being deposited on the surface of the coil body 10 by the electrodepositing step is baked in a baking oven.

The preprocessing step may include, for example, degreasing, etching of the surface and acid pickling.

It is also possible to form the insulative coat by re-dipping the coil body into an insulative coat forming solution such as an enamel solution and baking the same, or by wrapping an insulative film around the coil body, other than by electrodeposition.

After the formation of the insulative coat, the insulative locking members 20 are mounted to the spiral portion so as to prevent the spiral portion from expanding in the vertical direction.

In the one example, an insulative tape made from polyamide-imide or the like is used as the locking member 20 as shown in FIG. 2.

More specifically, the insulative tape is wrapped around the spiral portion 15 so as to straddle inner and outer side surfaces of the spiral portion 15, thereby preventing the spiral portion 15 from expanding in the vertical direction.

The insulative tape is useful in its thinness and its flexibility.

Alternatively, it is also possible to use as the locking member 20 a clip that is made from an insulative resin and has a U-shaped cross section.

As explained earlier, in the one example, the spiral forming region of the conductive wire 90 that forms the spiral portion 15 has a tapered cross section in which the thickness becomes thinner from the inner side (the first short edge) facing inward in the radial direction to the outer side (the second short edge) facing outward in the radial direction (FIG. 3).

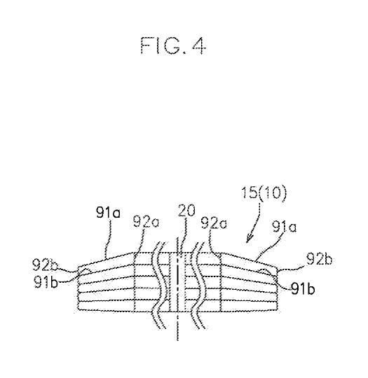

In such a case, in the locking step, the spiral portion 15 is preferably compressed or contracted in the vertical direction by bringing an upper end surface (the first long edge 91a) of the spiral forming region of one turn in the spiral portion 15 into contact with a lower end surface (the second long edge 91b) of the spiral forming region of a next turn that is upwardly adjacent to the one turn so that the spiral portion 15 has a height becoming shorter in the vertical direction from the inner side to the outer side in the radial direction. The spiral portion 15 is then kept in the compressed state (see FIG. 4) by the locking member 20.

Preferably, the shape or posture of the spiral portion 15 is kept by the locking member 20 in a more stable manner.

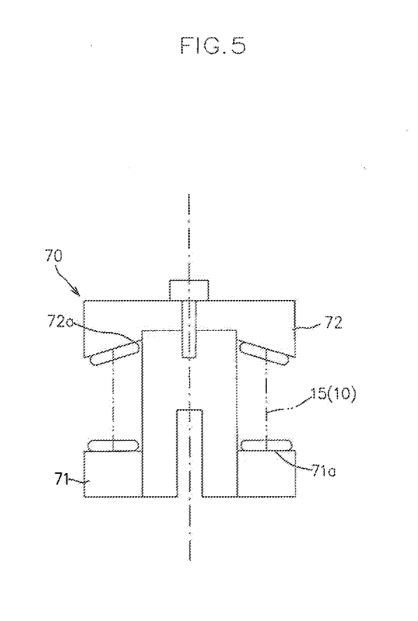

The compression of the spiral portion 15 in the vertical direction may be performed by, for example, a compressing device 70 including a lower member 71 and an upper member 72 as shown in FIG. 5. The lower member 71 has a mounting surface 71a on which the lower end surface of the spiral portion 15 is mounted. The upper member 72 has a contacting surface 72a with which the upper end surface of the spiral portion 15, which has been mounted on the mounting surface 71a of the lower member 71, is brought into contact. The contacting surface 72a is inclined so as to go downward from an inner side towards an outer side in a radial direction. The upper member 72 and the lower member 71 are capable of relatively moving so as to come close to and move away from each other, and are also capable of being fixed in a relative position.

The upper member 72 and the lower member 71 of the compressing device 70 are formed with slits (not shown) at the same position in a circumferential direction, the slit causing the spiral portion 15 to be outwardly exposed. The locking member 20 is wrapped around the spiral portion 15 through the slits.

After that, the spiral portion 15 with the locking member 20 being mounted thereto is sealed or covered by an insulative resin.

The locking member 20 prevents the posture of spiral portion 15 from changing, whereby the sealing step can easily and efficiently be performed without using a die.

More specifically, the configuration allows at least the spiral portion 15 to be dipped into the insulative resin solution in a state of being supported by the first end portion 11 and/or the second end portion 12, and also allows at least the spiral portion 15 to be sprayed with the insulative resin in a state of being suspended by the first and second end portions 11, 12, thereby easily and efficiently sealing the spiral portion 15 with the resin body 30.

After that, according to need, predetermined areas of the first and second end portions 11, 12 are cut out, or the insulative coats of the predetermined areas of the first and second end portions 11, 12 are removed to complete the molded coil 1.

Such a removal step may be performed before the sealing step.

What is claimed is:

1. A molded coil comprising:
a coil body that is formed by an elongated insulation-coated conductor, wherein the coil body has a spiral portion winded around in a spiral manner, a first end portion forming a beginning end of the spiral portion, and a second end portion forming a terminating end of the spiral portion,
an insulative locking member that keeps a shape of the spiral portion so as to prevent the spiral portion from expanding in a vertical direction, and an insulative resin body that covers the spiral portion with the locking member being attached thereto.

2. A molded coil according to claim 1,
wherein a spiral forming region of the insulation-coated conductor that forms the spiral portion includes an inner side surface facing inward in a radial direction, an outer side surface facing outward in the radial direction, an upper end surface connecting upper ends of the inner and outer side surfaces, and an lower end surface connecting lower ends of the inner and outer side surfaces, and wherein the spiral forming region of the insulation-coated conductor that forms the spiral portion has a tapered cross section in which a thickness becomes thinner from the inner side surface to the outer side surface, and
wherein the locking member keeps the spiral portion a compressed state in a vertical direction such that the upper end surface of the spiral forming region of one turn in the spiral portion is brought into contact with the lower end surface of the spiral forming region of a next turn that is upwardly adjacent to the one turn so that the spiral portion becomes shorter in the vertical direction from the inner side to the outer side in the radial direction.

3. A molded coil according to claim 1, wherein the locking member is formed by an insulative tape wrapped around the inner side surface, the upper end surface, the outer side surface, and the lower end surface of the spiral portion.

4. A method of manufacturing a molded coil, the method comprising,
a coiling step that forms, from an elongated conductive wire, a coil body including a spiral portion winded around in a spiral manner, a first end portion forming a beginning end of the spiral portion, and a second end portion forming a terminating end of the spiral portion,
a coating step that coats at least a portion of the conductive wire that forms the spiral portion with an insulative coat,
a locking step that keeps a shape of the spiral portion by using an insulative locking member to prevent the spiral portion from expanding in the vertical direction, and
a sealing step that seals at least the spiral portion with an insulative resin, the spiral portion having the locking member mounted thereto.

5. A method of manufacturing the molded coil according to claim 4,
wherein the elongated conductive wire has a quadrangular cross section defined by a pair of first and second long edges and a pair of first and second short edges,
wherein the coiling step forms the coil body by bending the conductive wire using the first short edge as a Lending fulcrum and laminating the conductive wire to have a plurality of turns,
wherein the spiral forming region of the conductive wire that forms the spiral portion has a tapered cross section in which a thickness becomes thinner from an inner side surface facing inward in a radial direction to an outer side surface facing outward in the radial direction, and
wherein the locking member keeps the spiral portion in a compressed state in the vertical direction such that an upper end surface of the spiral forming region of one turn in the spiral portion is brought into contact with a lower end surface of the spiral forming region of a next turn that is upwardly adjacent to the one turn so that the spiral portion has a height that becomes shorter from the inner side to the outer side in the radial direction.

6. A method of manufacturing the molded coil according to claim 4, wherein the sealing in the sealing step is achieved by dipping at least the spiral portion into an insulative resin solution or spraying at least the spiral portion with an insulative resin in a state where the coil body is suspended.
